(19) United States
(12) Patent Application Publication
(10) Pub. No.: US 2014/0009040 A1
(43) Pub. Date: Jan. 9, 2014

(54) SPINDLE MOTOR

(71) Applicant: SAMSUNG ELECTRO-MECHANICS CO., LTD., Suwon (KR)

(72) Inventors: Jung Hwan SONG, Suwon (KR); Shin Young Cheong, Suwon (KR); Heung Suk Go, Suwon (KR)

(21) Appl. No.: 13/651,759

(22) Filed: Oct. 15, 2012

(30) Foreign Application Priority Data
Jul. 5, 2012 (KR) 10-2012-0073465

(51) Int. Cl. H02K 5/16

(52) U.S. Cl. 310/425

(57) ABSTRACT

There is provided a spindle motor including: a stator rotatably supporting a rotor; and a stator core fixed to the stator and having a front end disposed to face a driving magnet included in the rotor and a coil wound therearound, wherein the stator includes a base member, an insertion groove being formed in the base member, and having a lower portion of the coil inserted therein.

### CROSS-REFERENCE TO RELATED APPLICATIONS

This application claims the priority of Korean Patent Application No. 10-2012-0073465 filed on Jul. 5, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized motor is used.

That is, the disk is mounted in the motor and is rotated at the time of motor driving, such that data stored on the disk may be read or data may be written to the disk.

In addition, the motor rotating the disk, a device converting electrical energy into mechanical energy using force applied to a conductor having a current flowing therein within a magnetic field, basically generates driving force rotating the disk through electromagnetic interaction between a magnet and a coil.

Further, the coil is wound around a stator core, and the stator core is installed on a base member so as to face the magnet. That is, the stator core is installed on the base member so as to be disposed in a space formed between the base member and a rotor hub, having the magnet mounted thereon.

Meanwhile, as hard disk drives have tended to be thinned, motors have tended to be miniaturized and thinned.

However, the motor has a limitation in being thinned due to the coil being wound around the stator core. That is, since the coil wound around the stator core installed on the base member should be spaced apart from the base member by a predetermined interval, a space corresponding to a height of the stator core including the coil wound therearound should be demanded. Therefore, the development of a structure capable of reducing an increase in a thickness of the motor due the stator core including the coil wound therearound has been in demand.

In addition, in the case of a structure in which the rotor hub including the magnet mounted thereon is disposed in a groove of the base member as disclosed in Japanese Patent Application Laid-Open No. 2008-109793, a thickness of the base member is reduced by the formation of the groove, such that strength of the base member may be deteriorated.

### RELATED ART DOCUMENT

### Patent Document

(Patent Document 1) Japanese Patent Laid-open Publication No. 2008-109793
(Patent Document 2) US Patent Laid-Open No. 2012/0033328

### SUMMARY OF THE INVENTION

An aspect of the present invention provides a spindle motor capable of being thinned and reducing a deterioration in a strength of a base member.

According to an aspect of the present invention, there is provided a spindle motor including: a stator rotatably supporting a rotor; and a stator core fixed to the stator and having a front end disposed to face a driving magnet included in the rotor and a coil wound therearound, wherein the stator includes a base member, an insertion groove being formed in the base member, and having a lower portion of the coil inserted therein.

The insertion groove may have a length in a radial direction, greater than a length of the coil in the radial direction, and smaller than a length of the stator core in the radial direction.

An edge of the stator core, disposed outwardly in a radial direction, may be supported by an upper surface of the base member.

A center of the driving magnet in an axial direction may be disposed at a higher position than a center of the stator core in the axial direction.

The stator core may be formed by stacking a plurality of single core sheets, each having a thin plate shape, and a front end portion of a single core sheet disposed on an uppermost portion among the plurality of single core sheets is provided with a bent part bent upwardly and disposed to face the driving magnet.

The spindle motor may further include a strength reinforcement member installed on a lower surface of the base member so as to be disposed below the insertion groove.

The strength reinforcement member may be made of a magnetic material.

The stator may include a lower thrust member fixed to the base member and a shaft having a lower end portion fixed to the lower thrust member.

The rotor may include a sleeve forming a bearing clearance with the shaft and the lower thrust member, and a rotor hub extended from the sleeve.

The sleeve may include a cylindrical wall portion inserted in a groove part of the lower thrust member so as to be disposed between the shaft and the lower thrust member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a schematic cross-sectional view showing a spindle motor according to another embodiment of the present invention;

FIG. 4 is an enlarged view showing part B of FIG. 3;

FIG. 5 is a schematic cross-sectional view showing a spindle motor according to another embodiment of the present invention;

FIG. 6 is a schematic cross-sectional view showing a spindle motor according to another embodiment of the present invention; and

FIG. 7 is a schematic cross-sectional view showing a spindle motor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

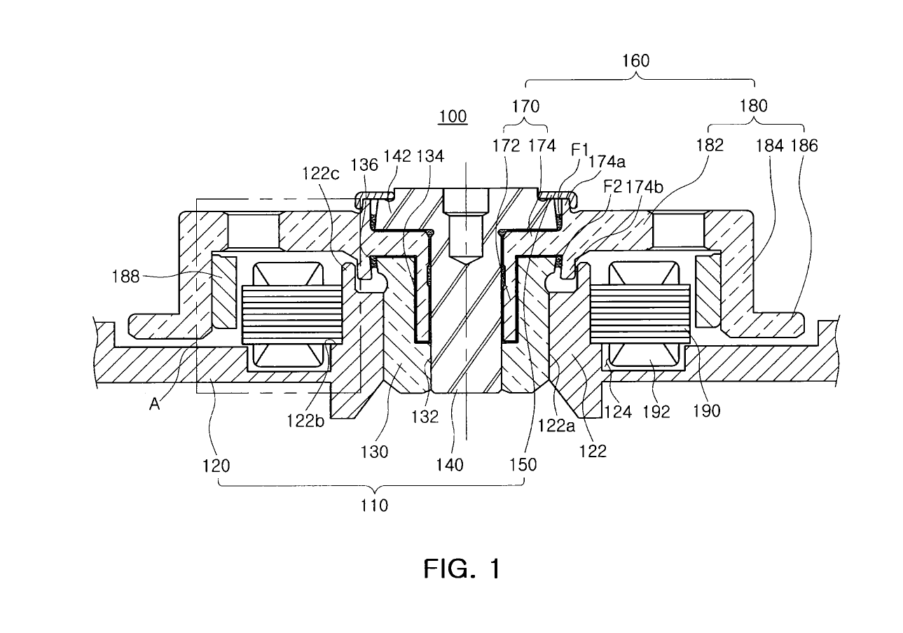

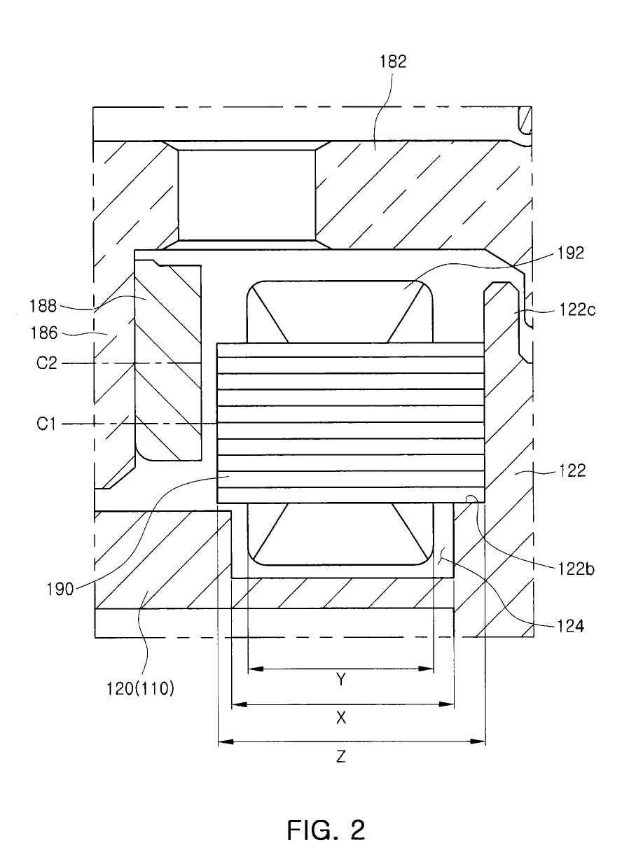

FIG. 1 is a cross-sectional view schematically showing a spindle motor according to an embodiment of the present invention, and FIG. 2 is an enlarged view showing part A of FIG. 1.

Referring to FIGS. 1 and 2, a spindle motor 100 according to an embodiment of the present invention may include a stator 110, a rotor 160, and a stator core 190.

Meanwhile, the spindle motor 100 according to the embodiment of the present invention may be, for example, a motor used in an information recording and reproducing device such as a hard disk driving device, or the like.

The stator 110 may rotatably support the rotor 160.

Meanwhile, the stator 110 may include a base member 120 including a protrusion part 122 on which the stator core 190 is mounted.

A detailed description of the stator 110 will be provided below. Here, the base member 120 included in the stator 110 will be first described in detail.

The base member 120 may include the protrusion part 122 having a mounting hole 122a formed therein. The protrusion part 122 may be extended upwardly in an axial direction and include a support part 122b formed at an outer peripheral surface thereof so as to support the stator core 190.

That is, the stator core 190 may be fixed to the protrusion part 122 in a state while being seated on the support part 122b of the protrusion part 122.

The case in which an inner peripheral portion of the stator core 190 is seated on the protrusion part of the base member 120 is described by way of example in the present embodiment, but is not limited thereto. For example, the stator core 190 may be mounted on a separate mounted member or a lower thrust member, a shape of which may be varied to mount the stator core 190 thereon. In this case, the base member 120 may not include the protrusion part 122.

Meanwhile, the protrusion part 122 may include a protrusion wall part 122c extended from an upper surface thereof. The protrusion wall part 122c may serve to form a labyrinth seal together with the rotor 160 to suppress evaporation of a lubricating fluid. A detailed description of the protrusion wall part 122c will be provided below.

In addition, the base member 120 may include an insertion groove 124 formed therein. A coil 192 is wound around the stator core 190, and a lower portion of the coil 192 is inserted in the insertion groove 124.

That is, in the case in which the stator core 190 is fixed to the protrusion part 122, the lower portion of the coil 192 may be inserted in the insertion groove 124.

Therefore, an increase in a thickness of the spindle motor 100 due to the coil 192 wound around the stator core 190 may be prevented. In other words, the lower portion of the coil 192 is inserted in the insertion groove 124, such that the spindle motor 100 may be thinned.

Meanwhile, the insertion groove 124 may have a length X in a radial direction, greater than a length Y of the coil 192 in the radial direction, the coil 192 being wound around the stator core 190, and smaller than a length Z of the stator core 190 in the radial direction.

Therefore, deterioration in strength of the base member 120 due to the insertion groove 124 may be reduced.

That is, since the insertion groove 124 has a length allowing for only the coil 192 wound around the stator core 190 to be inserted in the insertion groove 124, a portion of the base member 120, in which a thickness thereof is decreased due to the formation of the insertion groove 124 may be significantly reduced.

As a result, as compared to the case in which the insertion groove 124 is extended to an outer peripheral surface of the rotor 160, the portion of the base member 120, in which a thickness thereof is decreased may be reduced. Therefore, the deterioration in strength of the base member 120 due to the insertion groove 124 may be reduced.

In addition, the base member 120 may be manufactured by die-casting using al aluminum (Al) material. Alternatively, the base member 120 may also be molded by performing plastic working (for example, press working) on a steel plate.

That is, the base member 120 may be manufactured by various materials and various processing methods, and is not limited to the base member 120 shown in the accompanying drawings.

Meanwhile, the stator 110 may include a lower thrust member 130 and a shaft 140.

The lower thrust member 130 may be inserted in the mounting hole 122a of the protrusion part 122, and an outer peripheral surface of the lower thrust member 130 may be bonded to an inner peripheral surface of the protrusion part 122.

Here, the lower thrust member 130 may be fixed to the protrusion part 122 by any one of an adhesion method, a press-fitting method, and a welding method.

Meanwhile, the lower thrust member 130 may include a shaft insertion hole 132 formed in a central portion thereof such that the shaft 140 is inserted therein.

In addition, the lower thrust member 130 may include a groove part 134 having a diameter larger than that of the shaft insertion hole 132. A detailed description of the groove part 134 will be provided below.

In addition, an upper end portion of the outer peripheral surface of the lower thrust member 130 may be provided with an inclination part 136 in order to form a liquid-vapor interface together with the rotor 160.

The shaft 140 may have a lower end portion fixed to the lower thrust member 130. That is, the lower end portion of the shaft 140 may be inserted in the shaft insertion hole 132 to be fixed to the lower thrust member 130.

That is, the spindle motor 100 according to the embodiment of the present invention may have a shaft-fixed structure in which the shaft 140 is fixedly installed.

Further, the shaft 140 may include ea thrust part 142 formed on an upper end portion thereof, in order to generate thrust dynamic pressure at the time of rotation of the rotor 160. The thrust part 142 may be extended from the upper end portion of the shaft 140 in the radial direction.

Here, terms with respect to directions will be defined. As viewed in FIG. 1, the axial direction refers to a vertical direction, that is, a direction from the lower end portion of the shaft 140 toward the upper end portion thereof or a direction from the upper portion of the shaft 140 toward the lower portion thereof, and the radial direction refers to a horizontal direction, that is, a direction from the shaft 140 toward the outer peripheral surface of the rotor 160 or from the outer peripheral surface of the rotor 160 toward shaft 140.

In addition, a circumferential direction refers to a rotation direction along an outer peripheral surface of the shaft 140.

Meanwhile, an outer peripheral surface of the thrust part 142 may be inclined so as to form an interface between the lubricating fluid and air, together with the rotor 160. Further, an upper edge of the thrust part 142 may be stepped for a cap member 150.

In addition, the shaft 140 may form a bearing clearance to be filled with the lubricating fluid, together with the rotor 160. A detailed description of the bearing clearance will be provided at the time of describing the rotor 160.

The cap member 150 may serve to prevent the lubricating fluid from being leaked upwardly.

In addition, an edge of the cap member 150 may be bent downwardly in the axial direction and be installed on a protrusion 174a of a sleeve 170 to be described below.

The rotor 160 may rotate about the shaft 140. Meanwhile, the rotor 160 may include the sleeve 170 forming a bearing clearance together with the shaft 140 and the lower thrust member 130, and a rotor hub 180 extended from the sleeve 170.

The sleeve 170 may be disposed between the shaft 140 and the lower thrust member 130 to form the bearing clearance together with the shaft 140 and the lower thrust member 130. Further, the sleeve 170 may include a cylindrical wall portion 172 inserted in the groove part 134 of the lower thrust member 130 and a disk portion 174 disposed between the thrust part 142 of the shaft 140 and the lower thrust member 130.

In addition, the disk portion 174 may include the protrusion 174a formed at a distal end thereof and extended upwardly in the axial direction in order to form a liquid-vapor interface together with the outer peripheral surface of the thrust part 142 of the shaft 140 and an extension wall 174b formed at a distal end and extended downwardly in the axial direction in order to form a liquid-vapor interface together with the outer peripheral surface of the lower thrust member 130.

Meanwhile, the bending edge of the cap member 150 may be installed on an outer peripheral surface of the protrusion 174a.

In addition, the extension wall 174b may form the labyrinth seal together with the protrusion wall part 122c provided in the protrusion part 122 of the base member 120. That is, at the time of the installation the rotor 160, the extension wall 174b may be disposed on an inside of the protrusion wall part 122c, and an outer peripheral surface of the extension wall 174b and an inner peripheral surface of the protrusion wall part 122c may be spaced apart from each other by a micro interval to form the labyrinth seal suppressing a flow of the air.

As described above, the labyrinth seal is formed by the extension wall 174b and the protrusion wall part 122c to suppress the flow of the air, such that the evaporation of the lubricating fluid may be suppressed.

Here, the bearing clearance in which the lubricating fluid is filled will be described in more detail.

First, the interface between the lubricating fluid filled in the bearing clearance and the air (hereinafter, referred to as the ‘liquid-vapor interface’) may include, a first liquid-vapor interface F1 formed in a space formed by the outer peripheral surface of the thrust part 142 of the shaft 140 and the protrusion 174a of the disk portion 174 and, a second liquid-vapor interface formed in a space formed by the upper end portion of the outer peripheral surface of the lower thrust member 130 and the extension wall 174b.

Meanwhile, the first liquid-vapor interface F1 may be formed upwardly in axial direction, and the second liquid-vapor interface F2 may be formed downwardly in the axial direction.

Further, the lubricating fluid may be filled in the bearing clearance formed by the shaft 140 and the sleeve 170 and the bearing clearance formed by the sleeve 170 and the lower thrust member 130.

Meanwhile, the rotor hub 180 may be extended form the disk portion 174. Meanwhile, the rotor hub 180 may include a body part 182 having a disk shape, a magnet mounting part 184 extended from an edge of the body part 182 downwardly in the axial direction, and a disk seating part 186 extended from the magnet mounting part 184 in the radial direction.

In addition, the magnet mounting part 184 may include a driving magnet 188 fixedly installed on an inner surface thereof. Therefore, an inner surface of the driving magnet 188 may be disposed to face a front end of the stator core 190.

Meanwhile, the driving magnet 188 may be a permanent magnet generating magnetic force having a predetermined strength by alternately magnetizing an N pole and an S pole thereof in a circumferential direction.

Here, a rotational driving scheme of the rotor 160 will be simply described. When power is applied to the coil 192 wound around the stator core 190, driving force rotating the rotor 160 may be generated by electromagnetic interaction between the stator core 190 including the coil 192 wound therearound and the driving magnet 188, thereby rotating the rotor 160.

That is, the rotor 160 may be rotated by the electromagnetic interaction between the driving magnet 188 and the stator core 190 including the coil 192 wound therearound and disposed to face the driving magnet 188.

Meanwhile, since the stator core 190 is mounted on the protrusion part 122 of the base member 120 in such a manner that the lower portion of the coil 192 wound around the stator core 190 is inserted in the insertion groove 124 of the base member 120, a center C1 of the stator core 190 in the axial direction may be disposed at a lower position than a center C2 of the driving magnet 188 in the axial direction.

Therefore, as compared to the case in which the stator core 190 is not installed in such a manner that the lower portion of the coil 192 wound around the stator core 190 is inserted in the insertion groove 124, a distance between the center C1 of the stator core 190 in the axial direction and the center C2 of the driving magnet 188 in the axial direction may further increase.

As a result, magnetic force in the axial direction may be increased, such that at a configuration such as a pulling plate, or the like, for suppressing excessive floating of the rotor 160 may be omitted.

In addition, a space for installing the pulling plate is not required, such that the length of the insertion groove 124 in the radial direction may be reduced.

As described above, the lower portion of the coil 192 is inserted in the insertion groove 124 of the base member 120, whereby the spindle motor 100 may be thinned.

In other words, the increase in the thickness of the spindle motor 100 due to the coil 192 wound around the stator core 190 is reduced, whereby the spindle motor 100 may be thinned.

In addition, since the insertion groove 124 has the length X in the radial direction, greater than the length Y of the coil 192 in the radial direction, the coil 192 being wound around the stator core 190, and smaller than the length Z of the stator core 190 in the radial direction, deterioration in strength of the base member 120 due to the insertion groove 124 may be reduced.

Further, as the center C1 of the stator core 190 in the axial direction is disposed at a lower position than the center C2 of the driving magnet 188 in the axial direction, the distance between the two centers C1 and C2 is increased, such that the pulling plate may not be installed.

Hereinafter, a spindle motor according to another embodiment of the present invention will be described with reference to the accompanying drawings. However, the same components as the above-mentioned components will be denoted by the same reference numerals and a detailed description thereof will be omitted.

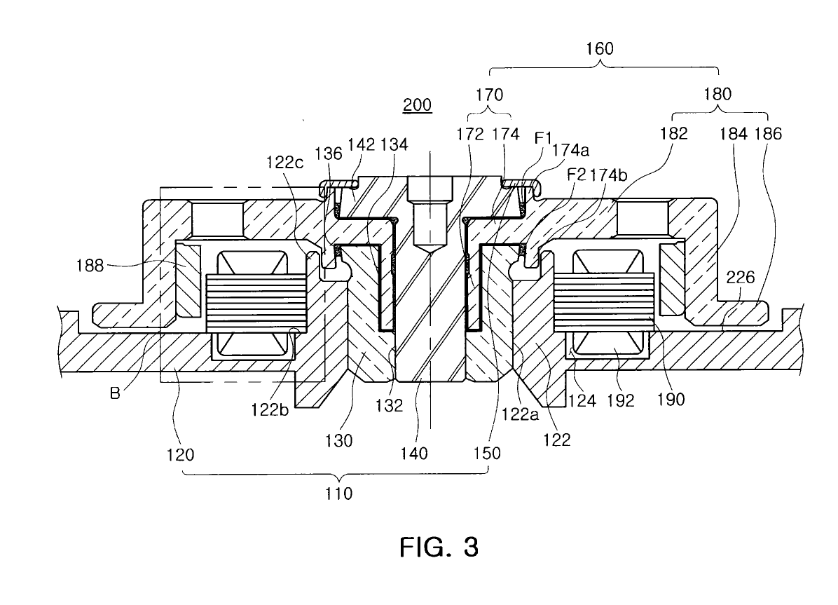

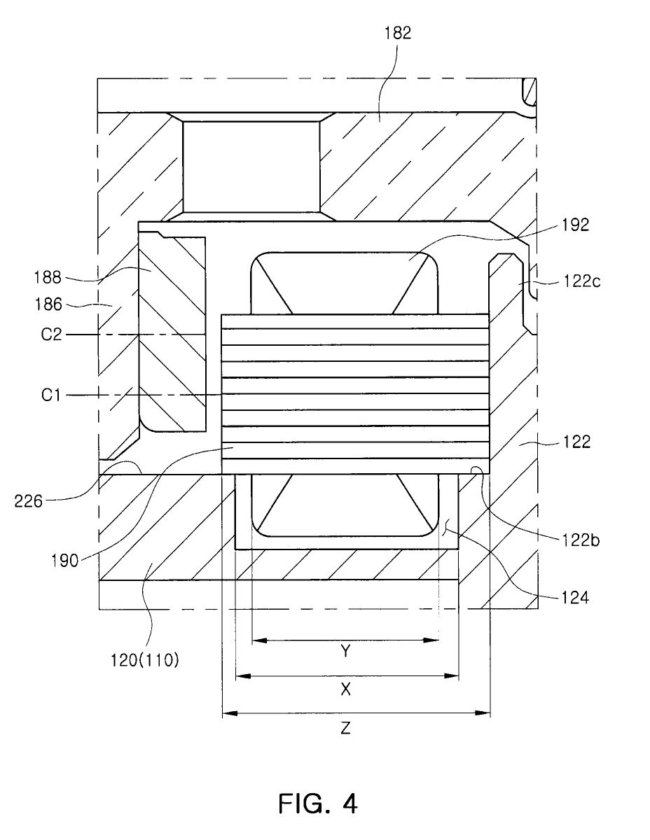

FIG. 3 is a schematic cross-sectional view showing a spindle motor according to another embodiment of the present invention, and FIG. 4 is an enlarged view showing part B of FIG. 3.

Referring to FIGS. 3 and 4, a spindle motor 200 according to the another embodiment of the present invention may have the same configurations as those of the spindle motor 100 according the embodiment of the present invention described above except for a portion to be described below.

Hereinafter, a configuration that is different from that of the spindle motor 100 according to the embodiment of the present invention described above will be described.

The stator core 190 may be fixed to the protrusion part 122 of the base member 120. That is, the stator core 190 may be fixed to the protrusion part 122 in a state while being seated on the support part 122b of the protrusion part 122.

Meanwhile, an edge of the stator core 190 may be supported by an upper surface 226 of the base member 120.

In other words, the inside of the stator core 190 may be supported by the support part 122b of the protrusion part 122, and the edge of the stator core 190 may be supported by the upper surface 226 of the base member 120.

Therefore, in the case in which vibrations are generated from the stator core 190, a vibration amount of the stator core 190 may be reduced.

In addition, in the case in which the length of the stator core 190 in the radial direction is increased due to implementation of thinness, the stator core 190 is more stably supported, such that a vibration amount may be reduced.

Meanwhile, since the spindle motor 200 according to another embodiment of the present invention may include all of the configurations included in the spindle motor 100 according to the embodiment of the present invention described above, the spindle motor 200 may implement all of the effects implemented by the spindle motor 100 according to the embodiment of the present invention described above, and a detailed description thereof will be omitted.

Hereinafter, a spindle motor according to another embodiment of the present invention will be described with reference to the accompanying drawings. However, the same configurations as those of the spindle motor 100 according to the embodiment of the present invention and the spindle motor 200 according to another embodiment of the present invention described above will be denoted by the same reference numerals and a detailed description thereof will be omitted

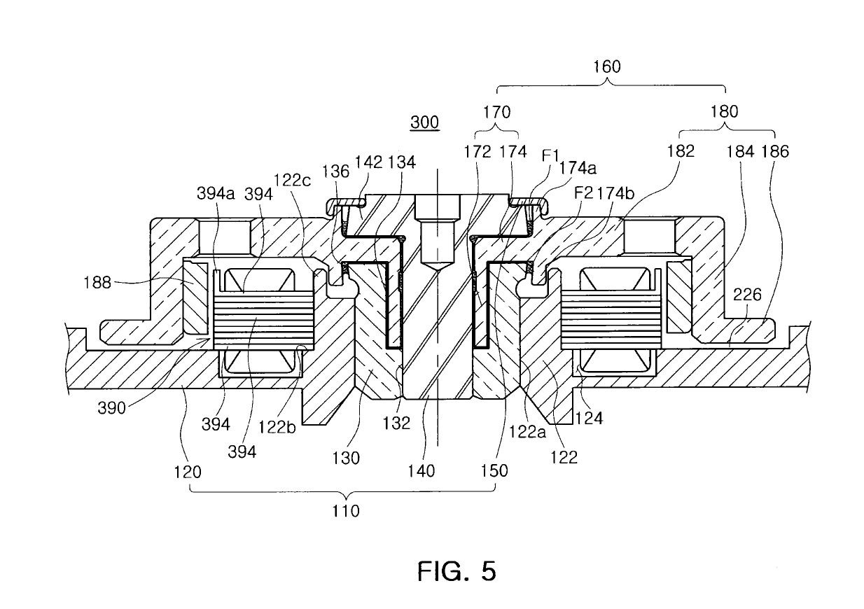

FIG. 5 is a schematic cross-sectional view showing a spindle motor according to another embodiment of the present invention.

Referring to FIG. 5, a spindle motor 300 according to the another embodiment of the present invention may have the same configurations as those of the spindle motor 200 according the embodiment of the present invention described above, except for a portion to be described below.

Hereinafter, the configuration that is different from that of the spindle motor 200 according to another embodiment of the present invention will be described.

A stator core 390 may be fixed to the protrusion part 122 of the base member 120. That is, the stator core 390 may be fixed to the protrusion part 122 while being seated on the support part 122b of the protrusion part 122.

Meanwhile, an edge of the stator core 390 may be supported by the upper surface 226 of the base member 120.

In other words, an inside of the stator core 390 may be supported by the support part 122b of the protrusion part 122, and the edge of the stator core 390 may be supported by the upper surface 226 of the base member 120.

In addition, a coil 392 is wound around the stator core 390 and a lower portion of the coil 392 may be inserted in the insertion groove 124 of the base member 120.

Meanwhile, the stator core 390 may be formed by stacking a plurality of single core sheets 394 having a thin plate shape, and a front end portion of the single core sheet 394 disposed on an uppermost portion among the plurality of single core sheets 394 may be provided with a bent part 394a bent upwardly and disposed to face the driving magnet 188.

As described above, the front end portion of the single core sheet 394 disposed on the uppermost portion is provided with the bent part 394a, such that driving force by electromagnetic interaction between the stator core 390 and the driving magnet 188 may be increased.

Meanwhile, since the spindle motor 300 according to another embodiment of the present invention may include all of the configurations included in the spindle motor 200 according to another embodiment of the present invention described above, the spindle motor 300 may implement all of the effects implemented by the spindle motor 100 according to the embodiment of the present invention and the spindle motor 200 according to another embodiment of the present invention described above, and a detailed description thereof will be omitted.

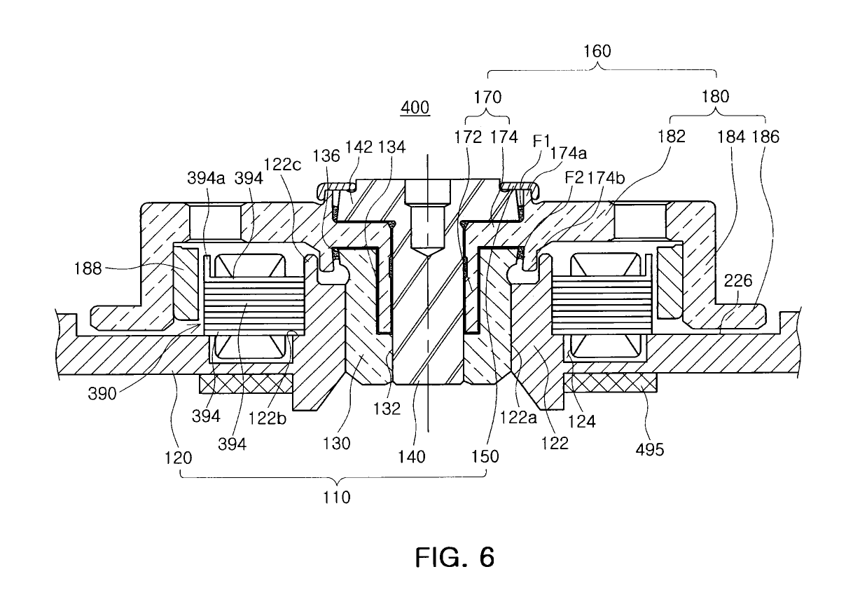

FIG. 6 is a schematic cross-sectional view showing a spindle motor according to another embodiment of the present invention.

Referring to FIG. 6, a spindle motor 400 according to the another embodiment of the present invention may have the same configurations as those of the spindle motor 300 according the embodiment of the present invention described above, except for a portion to be described below.

Hereinafter, the configuration that is different from that of the spindle motor 300 according to another embodiment of the present invention will be described.

A base member 120 may include a strength reinforcement member 495 installed thereon. That is, a lower surface of the base member 120 may include the strength reinforcement member installed thereon 495 so as to be disposed below the insertion groove 124.

The strength reinforcement member 495 may serve to reinforce the portion of the base member 120, in which strength is reduced due to the formation of the insertion groove 124, to thereby reinforce the strength of the base member 120. In addition, the strength reinforcement member 495 may be made of a magnetic material.

Therefore, leakage of a magnetic flux generated from the stator core 390 may be reduced.

That is, the portion of the base member 120, in which the insertion groove 124 is disposed, has a reduced thickness, such that the magnet flux generated from the stator core 390 may be leaked through this portion. However, the strength reinforcement member 495 is made of a magnetic material, such that the leakage of the magnetic flux may be reduced.

As described above, the strength of the base member 120 reduced due to the formation of the insertion groove 124 may be reinforced by the strength reinforcement member 495.

In addition, the leakage of the magnetic flux is reduced through the strength reinforcement member 495, such that driving force of a rotor 160 may be further increased.

Meanwhile, since the spindle motor 400 according to another embodiment of the present invention may include all of the configurations included in the spindle motor 300 according to the embodiment of the present invention described above, the spindle motor 400 may implement all of the effects implemented by the spindle motors 100, 200, and 300 described above, and a detailed description thereof will be omitted.

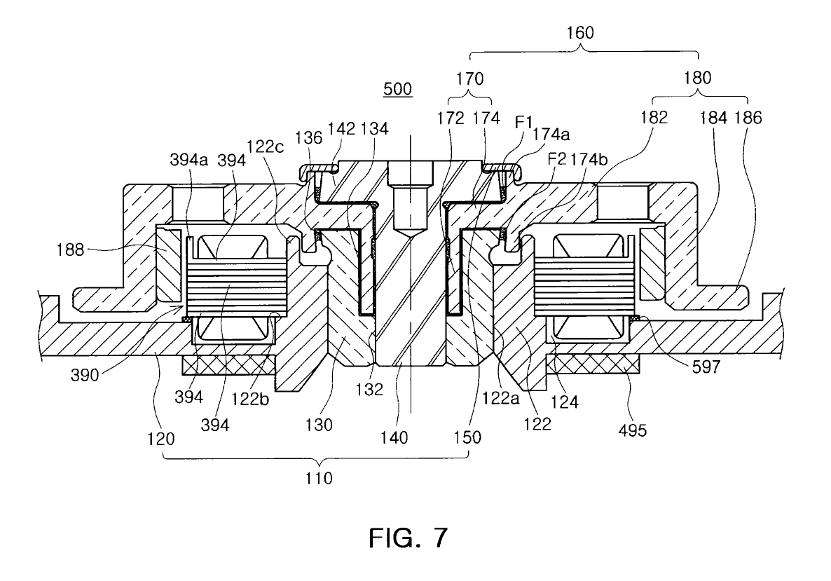

FIG. 7 is a schematic cross-sectional view showing a spindle motor according to another embodiment of the present invention.

Referring to FIG. 7, a spindle motor 500 according to the another embodiment of the present invention may have the same configurations as those of the spindle motor 400 according the embodiment of the present invention described above, except for a portion to be described below.

Hereinafter, the configuration that is different from that of the spindle motor 400 according to another embodiment of the present invention will be described.

The stator core 390 may be fixed to the protrusion part 122 of the base member 120. That is, the stator core 390 may be fixed to the protrusion part 122 while being seated on the support part 122b of the protrusion part 122.

Meanwhile, the edge of the stator core 390 may be supported by an elastic member 597 installed on the upper surface 226 of the base member 120.

In other words, the inside of the stator core 390 may be supported by the support part 122b of the protrusion part 122, and the edge of the stator core 390 may be supported by the elastic member 597 installed on the upper surface 226 of the base 120.

Meanwhile, the elastic member 597 may be made of rubber, an adhesive, or the like to absorb vibrations generated from the stator core 390.

As described above, both end portions of the stator core 390 may be supported, such that a vibration amount of the stator core 390 may be reduced in the case in which vibrations are generated from the stator core 390.

In addition, in the case in which the length of the stator core 390 in the radial direction is increased due to the implementation of thinness, the stator core 390 is more stably supported, such that a vibration amount may be reduced.

Further, since the edge of the stator core 390 is supported by the elastic member 597 having elasticity, in the case in which vibrations are generated, a vibration amount may be further reduced.

As set forth above, according to the present invention, the coil wound around the stator core is inserted in the insertion groove of the base member, whereby the spindle motor can be thinned.

In addition, the insertion groove has a length in the radial direction smaller than that of the stator core and greater than that of the coil, whereby the deterioration in the strength of the base member may be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a stator rotatably supporting a rotor; and
a stator core fixed to the stator and having a front end disposed to face a driving magnet included in the rotor and a coil wound therearound,
wherein the stator includes a base member,
an insertion groove being formed in the base member, and having a lower portion of the coil inserted therein.

2. The spindle motor of claim 1, wherein the insertion groove has a length in a radial direction, greater than a length of the coil in the radial direction, and smaller than a length of the stator core in the radial direction.

3. The spindle motor of claim 1, wherein an edge of the stator core, disposed outwardly in a radial direction is supported by an upper surface of the base member.

4. The spindle motor of claim 1, wherein a center of the driving magnet in an axial direction is disposed at a higher position than a center of the stator core in the axial direction.

5. The spindle motor of claim 1, wherein the stator core is formed by stacking a plurality of single core sheets, each having a thin plate shape, and
a front end portion of a single core sheet disposed on an uppermost portion among the plurality of single core sheets is provided with a bent part bent upwardly and disposed to face the driving magnet.

6. The spindle motor of claim 1, further comprising a strength reinforcement member installed on a lower surface of the base member so as to be disposed below the insertion groove.

7. The spindle motor of claim 6, wherein the strength reinforcement member is made of a magnetic material.

8. The spindle motor of claim 1, wherein the stator includes a lower thrust member fixed to the base member and a shaft having a lower end portion fixed to the lower thrust member.

9. The spindle motor of claim 8, wherein the rotor includes a sleeve forming a bearing clearance with the shaft and the lower thrust member, and a rotor hub extended from the sleeve.

10. The spindle motor of claim 9, wherein the sleeve includes a cylindrical wall portion inserted in a groove part of the lower thrust member so as to be disposed between the shaft and the lower thrust member.

11. A spindle motor comprising:
a stator rotatably supporting a rotor; and
a stator core fixed to the stator and having a front end disposed to face a driving magnet included in the rotor and a coil wound therearound,
wherein the stator includes a base member including a protrusion part on which the stator core is mounted,
the base member including an insertion groove formed therein,
the insertion groove being disposed in a vicinity of the protrusion part, and having a lower portion of the coil inserted therein and a length in a radial direction greater than a length of the coil in the radial direction and smaller than a length of the stator core in the radial direction,
an inside of the stator core being supported by a support surface of the protrusion part and an outside edge thereof being supported by an upper surface of the base member.
